(19) United States
(12) Patent Application Publication
(10) Pub. No.: US 2026/0229984 A1
(43) Pub. Date: Aug. 6, 2026

(54) POWER CONVERSION APPARATUS, MOTOR DRIVE APPARATUS, AND REFRIGERATION CYCLE APPLICATION APPARATUS

(71) Applicant: Mitsubishi Electric Corporation, Tokyo (JP)

(72) Inventors: Hiroyuki NAKAGAMI, Tokyo (JP); Takahiko KOBAYASHI, Tokyo (JP); Tomohiro KUTSUKI, Tokyo (JP)

(21) Appl. No.: 19/149,901

(22) PCT Filed: Mar. 23, 2023
(86) PCT No.: PCT/JP2023/011530

§ 371 Date: Jul. 22, 2025

(51) Int. Cl. H02M 1/15; H02M 1/00; H02M 1/36; H02M 1/42; H02M 5/458

(52) U.S. Cl. CPC H02M 1/15; H02M 1/0009; H02M 1/007; H02M 1/36; H02M 1/4266; H02M 5/4585

(57) ABSTRACT

A power conversion apparatus includes: a rectifier step-up circuit unit that rectifies alternating-current power and boosts voltage; a capacitor connected to an of the rectifier step-up circuit unit; an inverter circuit unit that converts power output from the rectifier step-up circuit unit and the capacitor; a current detection unit that detects a current value of current output from the inverter circuit unit; a power detection unit that detects a power state of the capacitor; and a control unit that allows irregular stop of boost operation and controls the inverter circuit unit such that a detection value detected by the power detection unit falls below a first reference value when at least one of a detection value detected by the current detection unit and the detection value detected by the power detection unit is a current value indicating an anomaly.

### FIELD

The present disclosure relates to a power conversion apparatus that converts alternating-current power into desired power, a motor drive apparatus, and a refrigeration cycle application apparatus.

### BACKGROUND

There is a power conversion apparatus that converts alternating-current power supplied from an alternating-current power supply into desired alternating-current power, and supplies the alternating-current power to a load such as an air conditioner. In this power conversion apparatus, for example, alternating-current power supplied from an alternating-current power supply is rectified by a converter, then smoothed by a smoothing capacitor, converted by an inverter into desired alternating current power, and output to a load. In such a power conversion apparatus, aging of the smoothing capacitor accelerates when a large current flows through the smoothing capacitor. It is conceivable that a method of increasing the capacitance of the smoothing capacitor or a method of increasing current ripple tolerance of the smoothing capacitor is used as a method for preventing the aging of the smoothing capacitor, but the cost of the smoothing capacitor increases and the apparatus increases in size.

The power conversion apparatus of Patent Literature 1 controls an inverter of a compressor so that a large current does not flow through a smoothing capacitor, and controls the charging and discharging current of the smoothing capacitor. As a result, the power conversion apparatus of Patent Literature 1 achieves prevention of deterioration of the smoothing capacitor and prevention of an increase in the size of the apparatus.

### CITATION LIST

### Patent Literature

Patent Literature 1: WO 2022/149210 A

### SUMMARY OF INVENTION

### Problem to be Solved by the Invention

However, the conventional technique described above has a problem in that when boost operation is stopped due to an anomaly in the power conversion apparatus in the case of a step-up converter, a current ripple flowing through the smoothing capacitor rapidly increases, and an excessive load is applied to the smoothing capacitor, leading to deterioration of the smoothing capacitor.

The present disclosure has been made in view of the above, and an object of the present disclosure is to obtain a power conversion apparatus capable of preventing deterioration of a smoothing capacitor even when a step-up Converter stops boost operation.

### Means to Solve the Problem

In order to solve the above-described problem and achieve the object, a power conversion apparatus of the present disclosure includes: a rectifier step-up circuit unit that rectifies first alternating-current power and boosts voltage, the first alternating current power being supplied from a commercial power supply; and a capacitor connected to an output end of the rectifier step-up circuit unit. In addition, the power conversion apparatus of the present disclosure includes: an inverter circuit unit that converts power output from the rectifier step-up circuit unit and the capacitor into second alternating-current power and outputs the second alternating-current power to a load, the inverter circuit unit being connected to both ends of the capacitor; a current detection unit that detects a current value of current output from the inverter circuit unit and sent to the load; and a power detection unit that detects a power state of the capacitor. Furthermore, the power conversion apparatus of the present disclosure includes: a control unit that controls the rectifier step-up circuit unit and the inverter circuit unit, the control unit causing the rectifier step-up circuit unit to irregularly stop boost operation when at least one of a detection value detected by the current detection unit and a detection value detected by the power detection unit is a current value indicating an anomaly, the control unit controlling the inverter circuit unit such that the detection value detected by the power detection unit falls below a first reference value in a case where the detection value detected by the power detection unit is equal to or greater than the first reference value when the boost operation is irregularly stopped.

### Effects of the Invention

The power conversion apparatus according to the present disclosure achieves the effect of preventing deterioration of a smoothing capacitor even when a step-up converter stops boost operation.

### BRIEF DESCRIPTION OF DRAWINGS

FIG. 1 is a diagram illustrating an exemplary configuration of a motor drive apparatus including a power conversion apparatus according to a first embodiment.

FIG. 2 is a flowchart illustrating operation of a control unit included in the power conversion apparatus according to the first embodiment.

FIG. 3 is a flowchart illustrating operation of a control unit included in a power conversion apparatus according to a second embodiment.

FIG. 4 is a flowchart illustrating operation of a control unit included in a power conversion apparatus according to a third embodiment.

FIG. 5 is a diagram illustrating an exemplary configuration of a motor drive apparatus including a power conversion apparatus according to a fourth embodiment.

FIG. 6 is a diagram illustrating an exemplary configuration of a motor drive apparatus including a power conversion apparatus according to a fifth embodiment.

FIG. 7 is a diagram illustrating an exemplary configuration of a motor drive apparatus including a power conversion apparatus according to a sixth embodiment.

FIG. 8 is a diagram illustrating an exemplary configuration of a refrigeration cycle application apparatus according to a seventh embodiment.

FIG. 9 is a diagram illustrating an exemplary configuration of processing circuitry included in the control unit of the power conversion apparatus according to the first embodiment, the processing circuitry being implemented by a processor and a memory.

FIG. 10 is a diagram showing an example of the processing circuitry included in the control unit of the power conversion apparatus according to the first embodiment, the processing circuitry being implemented by dedicated hardware.

### DESCRIPTION OF EMBODIMENTS

Hereinafter, power conversion apparatuses, motor drive apparatuses, and a refrigeration cycle application apparatus according to embodiments of the present disclosure will be described in detail with reference to the drawings.

### First Embodiment

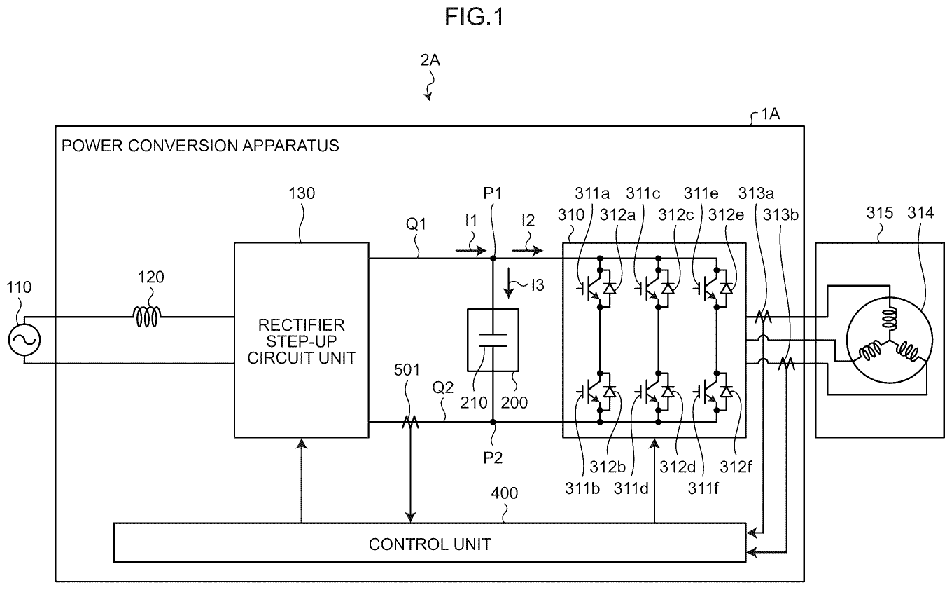

FIG. 1 is a diagram illustrating an exemplary configuration of a motor drive apparatus including a power conversion apparatus according to a first embodiment. A motor drive apparatus 2A includes a power conversion apparatus 1A and a compressor 315. The power conversion apparatus 1A is connected to a commercial power supply 110 and the compressor 315. The commercial power supply 110 is an example of an alternating-current power supply, and the compressor 315 is an example of a driver to be driven by the power conversion apparatus 1A. The power conversion apparatus 1A includes a reactor 120, a rectifier step-up circuit unit 130, a smoothing unit 200, an inverter circuit unit 310, compressor current detection units 313a and 313b, a control unit 400, and a bus current detection unit 501.

The compressor 315 includes a motor (compressor motor) 314. The compressor 315 is an example of a load to which the power conversion apparatus 1A supplies alternating-current power.

The reactor 120 is connected between the commercial power supply 110 and the rectifier step-up circuit unit 130. That is, the reactor 120 is located on one of connecting wires connecting the commercial power supply 110 and the rectifier step-up circuit unit 130. The reactor 120 implements improvement of a power factor, reduction of harmonics, power supply coordination, and the like.

The rectifier step-up circuit unit 130 is a step-up converter. The rectifier step-up circuit unit 130 has a function of rectifying alternating-current power (first alternating-current power) of a power supply voltage supplied from the commercial power supply 110 and a function of boosting a voltage of the rectified alternating current power. That is, the rectifier step-up circuit unit 130 is a step-up rectification circuit. The rectifier step-up circuit unit 130 has input ends connected to the commercial power supply 110 and output ends connected to the inverter circuit unit 310. The rectifier step-up circuit unit 130 outputs the rectified and boosted first alternating-current power.

The rectifier step-up circuit unit 130 is connected to a positive-side bus Q1, which is one of buses, and a negative-side bus Q2, which is another of the buses. Furthermore, the inverter circuit unit 310 is connected to the positive-side bus Q1 and the negative-side bus Q2. That is, the positive-side bus 01 is connected to one of the output ends of the rectifier step-up circuit unit 130 and one of input ends of the inverter circuit unit 310, and the negative-side bus Q2 is connected to another of the output ends of the rectifier step-up circuit unit 130 and another of the input ends of the inverter circuit unit 310. Then, the smoothing unit 200 is connected to a connection point Pl on the positive-side bus Q1 and a connection point P2 on the negative-side bus Q2.

In this manner, the smoothing unit 200 is connected to the output ends of the rectifier step-up circuit unit 130 and the input ends of the inverter circuit unit 310. The smoothing unit 200 includes a capacitor (smoothing capacitor) 210 as a smoothing element, and smooths the power rectified by the rectifier step-up circuit unit 130. The capacitor 210 is, for example, an electrolytic capacitor or a film capacitor. The capacitor 210 is connected to the output ends of the rectifier step-up circuit unit 130 and the input ends of the inverter circuit unit 310. The capacitor 210 has a capacitance for smoothing the power rectified by the rectifier step-up circuit unit 130. As a result of being smoothed by the capacitor 210, a voltage generated in the capacitor 210 has a waveform in which a voltage ripple corresponding to the frequency of the commercial power supply 110 is superimposed on a direct-current component, instead of a full-wave rectified waveform of the commercial power supply 110. Note that the commercial power supply 110 may be a single-phase power supply, or may be a three-phase power supply.

The bus current detection unit 501 detects a rectified current I1 flowing out of the rectifier step-up circuit unit 130 and outputs, to the control unit 400, a detection value of the rectified current I1 having been detected. In this manner, the bus current detection unit 501 detects a current input to the smoothing unit 200, i.e., a current rectified by the rectifier step-up circuit unit 130 and flowing into the smoothing unit 200 from the rectifier step-up circuit unit 130, and outputs a detected current value to the control unit 400. The bus current detection unit 501 can be used as a power detection unit that detects a power state of the capacitor 210.

The inverter circuit unit 310 is connected to both ends of the smoothing unit 200. The inverter circuit unit 310 includes switching elements 311a to 311f and freewheeling diodes 312a to 312f. In the inverter circuit unit 310, the switching elements 311a to 311f are turned on and off under the control of the control unit 400. This control causes power output from the rectifier step-up circuit unit 130 and the smoothing unit 200 to be converted into alternating-current power (second alternating-current power) having a desired amplitude and phase. That is, the inverter circuit unit 310 generates the second alternating-current power by turning on and off the switching elements 311a to 311f, and outputs the second alternating-current power to the motor 314.

Each of the compressor current detection units 313a and 313b detects a current value of one phase among three-phase currents output from the inverter circuit unit 310, and outputs the detected current value to the control unit 400. Note that acquisition of current values of two phases among current values of the three-phase currents output from the inverter circuit unit 310 enables the control unit 400 to calculate a current value of a current of remaining one phase output from the inverter circuit unit 310.

The motor 314 installed in the compressor 315 rotates according to the amplitude and phase of the alternating current power (second alternating current power) supplied from the inverter circuit unit 310, and performs compression operation.

Note that FIG. 1 illustrates a case where the motor 314 includes a Y-connection motor winding, but the motor winding included in the motor 314 is not limited to this example. The motor 314 may include a Δ-connection motor winding, or may include a motor winding configured such that it is possible to switch between Y-connection and Δ-connection.

In addition, arrangement of constituent elements of the power conversion apparatus 1A illustrated in FIG. 1 is an example, and the arrangement of the constituent elements is not limited to the example shown in FIG. 1. For example, the reactor 120 may be disposed at a stage subsequent to the rectifier step-up circuit unit 130. In the following description, each of the compressor current detection units 313a and 313b and the bus current detection unit 501 may be simply referred to as a “detection unit”. Furthermore, a current value detected by at least one of the compressor current detection units 313a and 313b and the bus current detection unit 501 may be simply referred to as a “detection value”.

The control unit 400 acquires a detection value of the rectified current I1 detected by the bus current detection unit 501 and detection values of an inverter input current I2 detected by the compressor current detection units 313a and 313b. That is, the control unit 400 acquires a current value of the current input to the smoothing unit 200, and acquires current values of the second alternating-current power converted by the inverter circuit unit 310.

In addition, the control unit 400 controls operation of the inverter circuit unit 310, specifically, the turning on and off of the switching elements 311a to 311f included in the inverter circuit unit 310, by using the detection value detected by each of the detection units.

Moreover, the control unit 400 controls the operation of the inverter circuit unit 310 such that the second alternating current power including a pulsation corresponding to a pulsation of power flowing from the rectifier step-up circuit unit 130 into the capacitor 210 of the smoothing unit 200 is output from the inverter circuit unit 310 to the compressor 315. The pulsation corresponding to the pulsation of the power flowing into the capacitor 210 of the smoothing unit 200 is, for example, a pulsation that varies depending on the frequency of the pulsation of the power flowing into the capacitor 210 of the smoothing unit 200. As a result, the control unit 400 reduces a capacitor current I3 that is a charging and discharging current of the capacitor 210. The control unit 400 performs control such that any of the speed, voltage, and current of the motor 314 is put in a desired state. Note that the control unit 400 need not use all the detection values acquired from the detection units, and may perform control by using some of the detection values.

Next, characteristic operation of the control unit 400 in the first embodiment will be described. The control unit 400 controls the rectifier step-up circuit unit 130 and the inverter circuit unit 310 based on a detection value of current detected by at least one of the compressor current detection units 313a and 313b and the bus current detection unit 501.

When at least one of the compressor current detection units 313a and 313b and the bus current detection unit 501 detects a current value indicating an anomaly of the motor drive apparatus 2A during boost operation of the rectifier step-up circuit unit 130, the control unit 400 causes the rectifier step-up circuit unit 130 to stop the boost operation. The current value indicating an anomaly of the motor drive apparatus 2A is a current value that falls outside an allowable range.

In addition, when a current value (current value of current input to the smoothing unit 200) detected by the bus current detection unit 501 is equal to or greater than a first reference value set in advance in the control unit 400, the control unit 400 controls the inverter circuit unit 310 such that the input current value falls below the first reference value. When the input current value detected by the bus current detection unit 501 is less than the first reference value, the control unit 400 maintains inverter control having been performed before the stop of the boost operation.

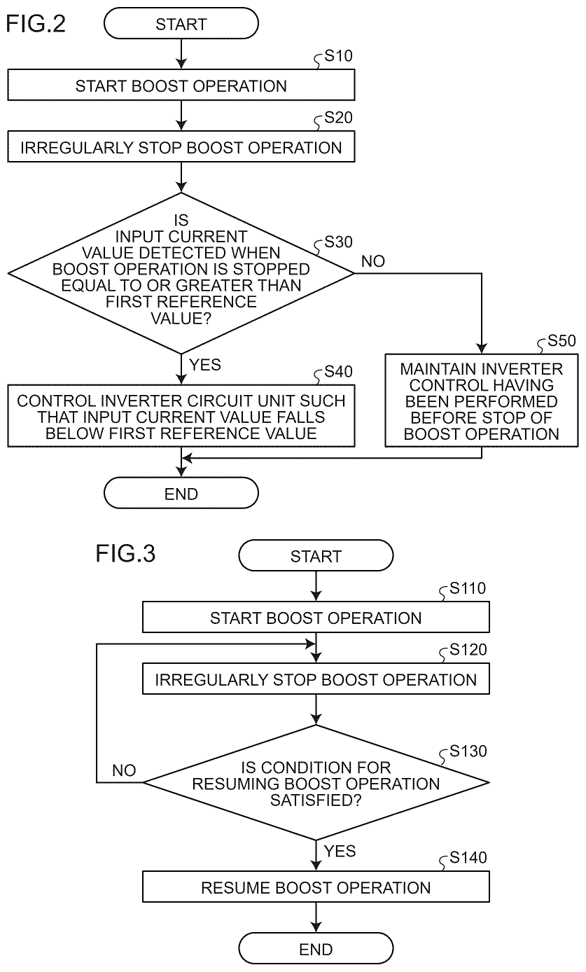

Here, operation of the control unit 400 will be described with reference to a flowchart. FIG. 2 is a flowchart illustrating operation of the control unit included in the power conversion apparatus according to the first embodiment. When the power conversion apparatus 1A starts operation, the control unit 400 causes the rectifier step-up circuit unit 130 to start boost operation, by controlling the rectifier step-up circuit unit 130 (step S10). Each of the compressor current detection units 313a and 313b and the bus current detection unit 501 detects a current value, and sends, to the control unit 400, a detection value that is a detection result.

When at least one of the compressor current detection units 313a and 313b and the bus current detection unit 501 detects a current value indicating an anomaly of the motor drive apparatus 2A during the boost operation, the control unit 400 causes the rectifier step-up circuit unit 130 to irregularly stop the boost operation, by controlling the rectifier step-up circuit unit 130 (step S20).

The control unit 400 determines whether a current value (current value detected by the bus current detection unit 501) of current input to the smoothing unit 200 when boost operation is irregularly stopped is equal to or greater than the predetermined first reference value (step S30).

In a case where the current value of the current input to the smoothing unit 200 when the boost operation is irregularly stopped is equal to or greater than the predetermined first reference value (step S30, Yes), the control unit 400 controls the inverter circuit unit 310 such that the input current value falls below the first reference value (step S40). For example, the control unit 400 controls the inverter circuit unit 310 such that a peak value of the input current value falls below the first reference value.

Meanwhile, in a case where the current value of the current input to the smoothing unit 200 when the boost operation is irregularly stopped is less than the predetermined first reference value (step S30, No), the control unit 400 maintains inverter control having been performed before the stop of the boost operation (step S50).

As described above, in a case where the current value of the current input to the smoothing unit 200 when the boost operation is irregularly stopped is equal to or greater than the first reference value, the control unit 400 of the first embodiment controls the inverter circuit unit 310 such that the input current value falls below the first reference value. As a result, the power conversion apparatus 1A can reduce the capacitor current I3, and can prevent a rapid increase in the current ripple flowing through the capacitor 210 even when the rectifier step-up circuit unit 130, which is a step-up converter, stops boost operation. Therefore, when the rectifier step-up circuit unit 130 stops boost operation, the power conversion apparatus LA can prevent application of an excessive load to the capacitor 210, and can prevent deterioration and failure of the capacitor 210.

### Second Embodiment

Next, a second embodiment will be described with reference to FIG. 3. In the second embodiment, after irregularly stopping boost operation, the control unit 400 resumes the boost operation if a condition (resuming condition) for resumption of the boost operation is satisfied. Note that since the motor drive apparatus 2A of the second embodiment has the same configuration as the motor drive apparatus 2A of the first embodiment, description of the configuration of the motor drive apparatus 2A will be omitted.

FIG. 3 is a flowchart illustrating operation of a control unit included in a power conversion apparatus according to the second embodiment. When the power conversion apparatus 1A starts operation, the control unit 400 causes the rectifier step-up circuit unit 130 to start boost operation, by controlling the rectifier step-up circuit unit 130 (step S110). Each of the compressor current detection units 313a and 313b and the bus current detection unit 501 detects a current value, and sends, to the control unit 400, a detection value that is a detection result.

When at least one of the compressor current detection units 313a and 313b and the bus current detection unit 501 detects a current value indicating an anomaly of the motor drive apparatus 2A during the boost operation, the control unit 400 causes the rectifier step-up circuit unit 130 to irregularly stop the boost operation, by controlling the rectifier step-up circuit unit 130 (step S120).

When causing boost operation to be irregularly stopped, the control unit 400 determines whether to resume the boost operation (return to a boost operation state). The control unit 400 determines whether to resume the boost operation, based on whether the condition for resumption of the boost operation is satisfied (step S130).

When the condition for resumption of the boost operation is not satisfied (step S130, No), the control unit 400 returns to the process of step S120, and maintains the rectifier step-up circuit unit 130 irregularly stopping the boost operation.

When the condition for resumption of the boost operation is satisfied (step S130, Yes), the control unit 400 causes the rectifier step-up circuit unit 130 to resume the boost operation such that boost operation is performed in a state in which the boost operation was performed before being irregularly stopped (step S140).

As described above, the control unit 400 of the second embodiment resumes boost operation when the condition for resumption of the boost operation is satisfied after the irregular stop of the boost operation. Therefore, even after the irregular stop of the boost operation, the power conversion apparatus 1A can quickly return to a state in which the power conversion apparatus 1A was before the irregular stop.

### Third Embodiment

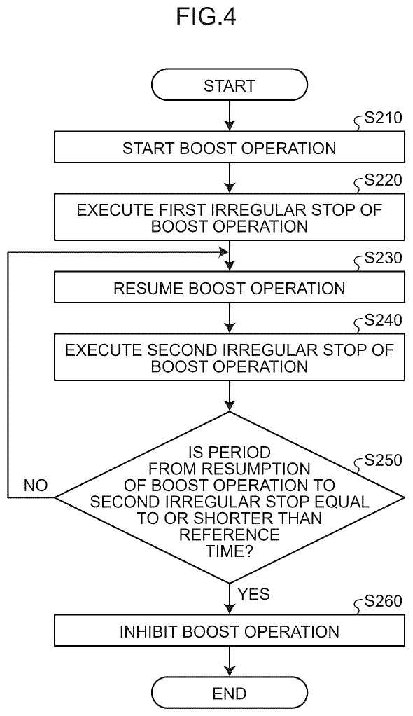

Next, a third embodiment will be described with reference to FIG. 4. Operation of the control unit 400 to be performed when an irregular stop occurs once has been described in the second embodiment. Meanwhile, in the third embodiment, a description will be given of operation of the control unit 400 to be performed when an irregular stop occurs consecutively. Note that since the motor drive apparatus 2A of the third embodiment has the same configuration as the motor drive apparatus 2A of the first embodiment, description of the configuration of the motor drive apparatus 2A will be omitted.

FIG. 4 is a flowchart illustrating operation of a control unit included in a power conversion apparatus according to the third embodiment. When the power conversion apparatus 1A starts operation, the control unit 400 causes the rectifier step-up circuit unit 130 to start boost operation, by controlling the rectifier step-up circuit unit 130 (step S210). Each of the compressor current detection units 313a and 313b and the bus current detection unit 501 detects a current value, and sends, to the control unit 400, a detection value that is a detection result.

When at least one of the compressor current detection units 313a and 313b and the bus current detection unit 501 detects a current value indicating an anomaly of the motor drive apparatus 2A during the boost operation, the control unit 400 causes the rectifier step-up circuit unit 130 to irregularly stop the boost operation, by controlling the rectifier step-up circuit unit 130. That is, the control unit 400 executes a first irregular stop of the boost operation (step S220).

When a specific condition is satisfied after the irregular stop of the boost operation, the control unit 400 resumes the boost operation (step S230). Thereafter, when at least one of the compressor current detection units 313a and 313b and the bus current detection unit 501 detects a current value indicating an anomaly of the motor drive apparatus 2A during the boost operation, the control unit 400 controls the rectifier step-up circuit unit 130, thereby causing the rectifier step-up circuit unit 130 to irregularly stop the boost operation. That is, the control unit 400 executes a second irregular stop of the boost operation (step S240). Then, the control unit 400 determines whether to resume the boost operation or inhibit the boost operation. Specifically, the control unit 400 determines whether to resume the boost operation or inhibit the boost operation, based on time from resumption of the previous boost operation to an irregular stop of the latest boost operation. That is, the control unit 400 determines whether a period from resumption of the boost operation to the second irregular stop is equal to or shorter than a reference time (step S250). Hereinafter, the period from the resumption of the boost operation to the second irregular stop may be referred to as a resuming operation period.

When the resuming operation period is longer than the reference time (step S250, No), the control unit 400 returns to the process of step S230, and resumes the boost operation. That is, when resumed boost operation is stable and the resuming operation period is longer than the reference time, the control unit 400 resumes the boost operation.

Meanwhile, when the resuming operation period is equal to or shorter than the reference time (step S250, Yes), the control unit 400 inhibits the boost operation (step S260). That is, the control unit 400 inhibits the boost operation when the resumed boost operation is unstable and the resuming operation period is equal to or shorter than the reference time. In this case, the control unit 400 does not cause the boost operation to be performed even when the resuming condition for resumption of the boost operation is satisfied.

When the period (resuming operation period) from the resumption of the previous boost operation to the irregular stop of the latest boost operation is extremely short, it is conceivable that not an accidental anomaly but a chronic defect may have occurred in the motor drive apparatus 2A. In such a state, the rectifier step-up circuit unit 130 constantly repeats boost operation and an irregular stop, so that the motor drive apparatus 2A becomes unstable. Therefore, in the third embodiment, when the resuming operation period is equal to or shorter than the reference time, the control unit 400 inhibits boost operation.

As described above, in a case where the resuming operation period is equal to or shorter than the reference time, the control unit 400 included in the power conversion apparatus 1A of the third embodiment inhibits boost operation. It is thus possible to prevent unstable operation of the motor drive apparatus 2A. As a result, the power conversion apparatus 1A can prevent an overload on the capacitor 210.

### Fourth Embodiment

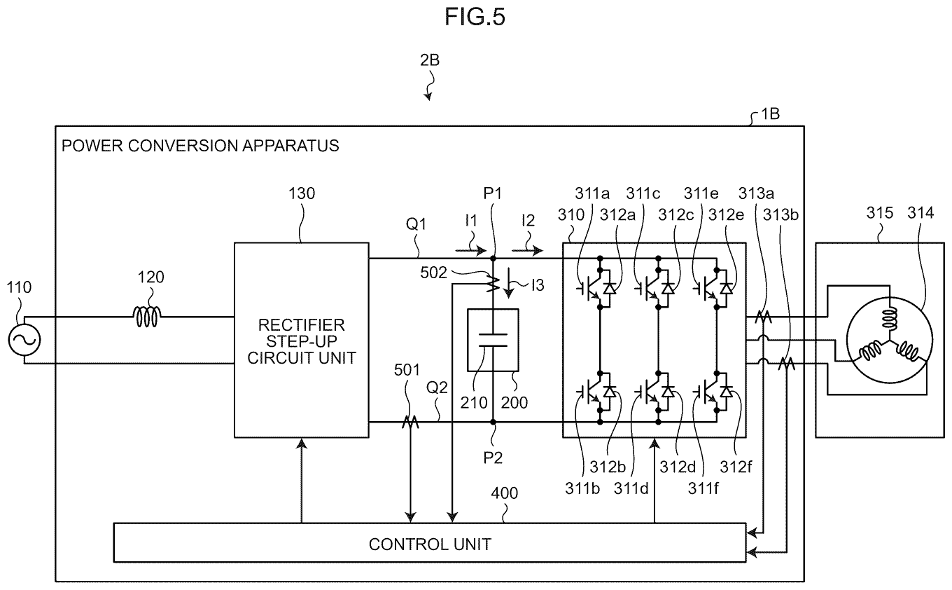

Next, a fourth embodiment will be described with reference to FIG. 5. In the fourth embodiment, in a case where the capacitor current I3 flowing through the smoothing unit 200 is equal to or greater than a second reference value when boost operation is irregularly stopped, the control unit 400 controls the inverter circuit unit 310 such that the capacitor current I3 falls below the second reference value.

FIG. 5 is a diagram illustrating an exemplary configuration of a motor drive apparatus including a power conversion apparatus according to the fourth embodiment. Among constituent elements illustrated in FIG. 5, constituent elements that achieve the same functions as the constituent elements of the motor drive apparatus 2A of the first embodiment illustrated in FIG. 1 are denoted by the same reference numerals, and redundant description will be omitted.

Comparing a motor drive apparatus 2B of the fourth embodiment with the motor drive apparatus 2A of each of the first to third embodiments, the motor drive apparatus 2B includes a power conversion apparatus 1B instead of the power conversion apparatus 1A. The power conversion apparatus 1B includes the constituent elements included in the power conversion apparatus 1A and a smoothing capacitor current detection unit 502.

The smoothing capacitor current detection unit 502 is connected to a point where only the capacitor current I3 flowing through the smoothing unit 200 can be detected. The smoothing capacitor current detection unit 502 is located on, for example, a connecting wire connecting the connection point P1 and the smoothing unit 200. The smoothing capacitor current detection unit 502 sends a detection value of the capacitor current I3 to the control unit 400.

As a result, the control unit 400 acquires the detection value detected by the smoothing capacitor current detection unit 502. In a case where a detection value of the capacitor current I3 detected by the smoothing capacitor current detection unit 502 at the time of an irregular stop of boost operation is equal to or greater than the second reference value set in advance in the control unit 400, the control unit 400 controls the inverter circuit unit 310 such that the capacitor current I3 falls below the second reference value. When the detection value of the capacitor current I3 is less than the second reference value, the control unit 400 maintains inverter control having been performed before the stop of the boost operation.

As described above, in the fourth embodiment, the smoothing capacitor current detection unit 502 detects only the capacitor current I3 flowing through the smoothing unit 200. The control unit 400 controls the inverter circuit unit 310 such that the capacitor current I3 falls below the second reference value in a case where a detection value of the capacitor current I3 is equal to or greater than the second reference value when the boost operation is irregularly stopped. As a result, the power conversion apparatus 1B can prevent an overload on the capacitor 210 when the boost operation is irregularly stopped.

In addition, the power conversion apparatus 1B can control the inverter circuit unit 310 such that a detection value of the rectified current I1 detected by the bus current detection unit 501 falls below the first reference value, and that the capacitor current I3 detected by the smoothing capacitor current detection unit 502 falls below the second reference value. As a result, the power conversion apparatus 1B can prevent an overload on the capacitor 210 with higher accuracy than in the case of the first embodiment.

### Fifth Embodiment

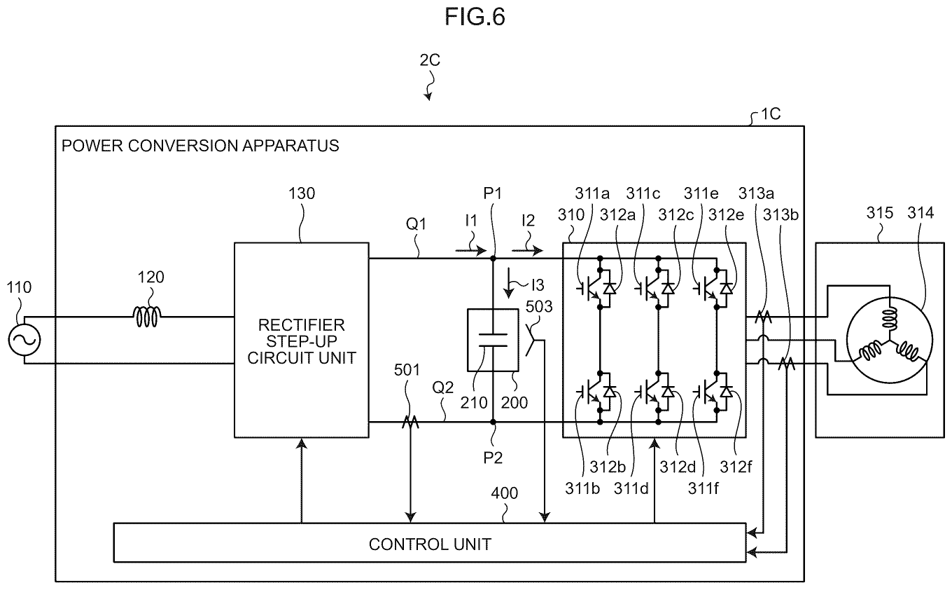

Next, a fifth embodiment will be described with reference to FIG. 6. In the fifth embodiment, the control unit 400 estimates the capacitor current I3, based on the trend of a voltage across the smoothing unit 200 applied when the boost operation is irregularly stopped. The control unit 400 controls the inverter circuit unit 310 such that the estimated capacitor current I3 falls below a third reference value.

FIG. 6 is a diagram illustrating an exemplary configuration of a motor drive apparatus including a power conversion apparatus according to the fifth embodiment.

Among constituent elements illustrated in FIG. 6, constituent elements that achieve the same functions as the constituent elements of the motor drive apparatus 2A of the first embodiment illustrated in FIG. 1 are denoted by the same reference numerals, and redundant description will be omitted.

Comparing a motor drive apparatus 2C of the fifth embodiment with the motor drive apparatus 2A of each of the first to third embodiments, the motor drive apparatus 2C includes a power conversion apparatus 1C instead of the power conversion apparatus 1A. The power conversion apparatus 1C includes the constituent elements included in the power conversion apparatus 1A and a smoothing capacitor voltage detection unit 503.

The smoothing capacitor voltage detection unit 503 is a detection unit that detects a voltage across the smoothing unit 200. The smoothing capacitor voltage detection unit 503 is connected in such a way as to detect the voltage across the smoothing unit 200. The smoothing capacitor voltage detection unit 503 is connected to, for example, a connecting wire connecting the connection point P1 and the capacitor 210 and a connecting wire connecting the connection point P2 and the capacitor 210. The smoothing capacitor voltage detection unit 503 sends a detection value of the voltage to the control unit 400.

As a result, the control unit 400 acquires the detection value detected by the smoothing capacitor voltage detection unit 503. The control unit 400 estimates the capacitor current I3 based on the trend of the detection value of the voltage detected by the smoothing capacitor voltage detection unit 503.

The control unit 400 may estimate the capacitor current I3 based on the amount of change in the detection value of the voltage detected by the smoothing capacitor voltage detection unit 503 in a specific period, or may estimate the capacitor current I3 based on a detection value of the voltage detected at one more timings. Hereinafter, a description will be given of a case where the control unit 400 estimates the capacitor current I3, based on a detection value of the voltage detected at a specific timing.

In a case where the estimated capacitor current I3 is equal to or greater than the third reference value set in advance in the control unit 400, the control unit 400 controls the inverter circuit unit 310 such that the capacitor current I3 falls below the third reference value. That is, when the estimated capacitor current I3 is equal to or greater than the third reference value, the control unit 400 controls the inverter circuit unit 310 such that the capacitor current I3 estimated on the basis of a voltage detected after the control falls below the third reference value. When the capacitor current I3 estimated on the basis of the detection value of the voltage detected by the smoothing capacitor voltage detection unit 503 is less than the third reference value, the control unit 400 maintains inverter control having been performed before the stop of boost operation.

As described above, in the fifth embodiment, the smoothing capacitor voltage detection unit 503 detects the voltage across the smoothing unit 200. The control unit 400 estimates the capacitor current I3, based on a detection value of the voltage. Then, when the estimated capacitor current I3 is equal to or greater than the third reference value, the control unit 400 controls the inverter circuit unit 310 such that the capacitor current I3 estimated thereafter falls below the third reference value. As a result, the power conversion apparatus 1C can prevent an overload on the capacitor 210 by not using a dedicated detection unit for detecting the capacitor current I3 which is a capacitor current, but using the smoothing capacitor voltage detection unit 503 being used for another purpose. Thus, the number of detection units can be reduced.

In addition, the power conversion apparatus 1C can control the inverter circuit unit 310 such that a detection value of the rectified current I1 detected by the bus current detection unit 501 falls below the first reference value, and that a detection value of the voltage detected by the smoothing capacitor voltage detection unit 503 falls below the third reference value. As a result, the power conversion apparatus 1C can prevent an overload on the capacitor 210 with higher accuracy than in the case of the first embodiment.

### Sixth Embodiment

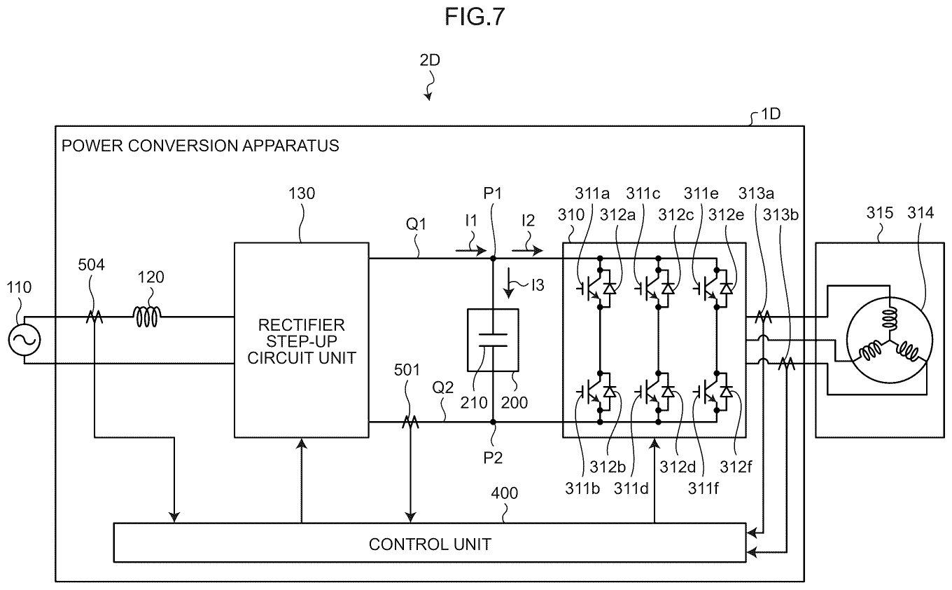

Next, a sixth embodiment will be described with reference to FIG. 7. In the sixth embodiment, the control unit 400 estimates the capacitor current I3 based on the trend of current input from the commercial power supply 110 when the boost operation is irregularly stopped, and controls the inverter circuit unit 310 such that the estimated capacitor current I3 falls below a fourth reference value.

FIG. 7 is a diagram illustrating an exemplary configuration of a motor drive apparatus including a power conversion apparatus according to the sixth embodiment. Among constituent elements illustrated in FIG. 7, constituent elements that achieve the same functions as the constituent elements of the motor drive apparatus 2A of the first embodiment illustrated in FIG. 1 are denoted by the same reference numerals, and redundant description will be omitted.

Comparing a motor drive apparatus 2D of the sixth embodiment with the motor drive apparatus 2A of each of the first to third embodiments, the motor drive apparatus 2D includes a power conversion apparatus 1D instead of the power conversion apparatus 1A. The power conversion apparatus ID includes the constituent elements included in the power conversion apparatus 1A and an input current detection unit 504.

The input current detection unit 504 is connected between the commercial power supply 110 and the reactor 120. The input current detection unit 504 detects a current value of an input current input to the power conversion apparatus 1D by the commercial power supply 110. The input current detection unit 504 sends a detection value of the input current to the control unit 400.

As a result, the control unit 400 acquires the detection value detected by the input current detection unit 504. The control unit 400 estimates the capacitor current I3 based on the trend of the detection value of the input current detected by the input current detection unit 504.

The control unit 400 may estimate the capacitor current I3 based on the amount of change in the detection value of the input current detected by the input current detection unit 504 in a specific period, or may estimate the capacitor current I3 based on a detection value of the input current detected at one or more timings. Hereinafter, a description will be given of a case where the control unit 400 estimates the capacitor current I3 based on a detection value of the input current detected at a specific timing.

In a case where the estimated capacitor current I3 is equal to or greater than the fourth reference value set in advance in the control unit 400, the control unit 400 controls the inverter circuit unit 310 such that the capacitor current I3 falls below the fourth reference value. That is, when the estimated capacitor current I3 is equal to or greater than the fourth reference value, the control unit 400 controls the inverter circuit unit 310 such that the capacitor current I3 estimated on the basis of an input current detected after the control falls below the fourth reference value. When the capacitor current I3 estimated on the basis of a detection value of the input current detected by the input current detection unit 504 is less than the fourth reference value, the control unit 400 maintains inverter control having been performed before the stop of boost operation.

As described above, in the sixth embodiment, the input current detection unit 504 detects an input current from the commercial power supply 110. The control unit 400 estimates the capacitor current I3, based on a detection value of the input current. Then, when the estimated capacitor current I3 is equal to or greater than the fourth reference value, the control unit 400 controls the inverter circuit unit 310 such that the capacitor current I3 estimated thereafter falls below the fourth reference value. As a result, the power conversion apparatus 1D can prevent an overload on the capacitor 210 by not using a dedicated detection unit for detecting the capacitor current I3 which is a capacitor current, but using the input current detection unit 504 being used for another purpose. Thus, the number of detection units can be reduced.

In addition, the power conversion apparatus 1D can control the inverter circuit unit 310 such that a detection value of the rectified current I1 detected by the bus current detection unit 501 falls below the first reference value, and that a detection value of the input current detected by the input current detection unit 504 falls below the fourth reference value. As a result, the power conversion apparatus 1D can prevent an overload on the capacitor 210 with higher accuracy than in the case of the first embodiment.

### Seventh Embodiment

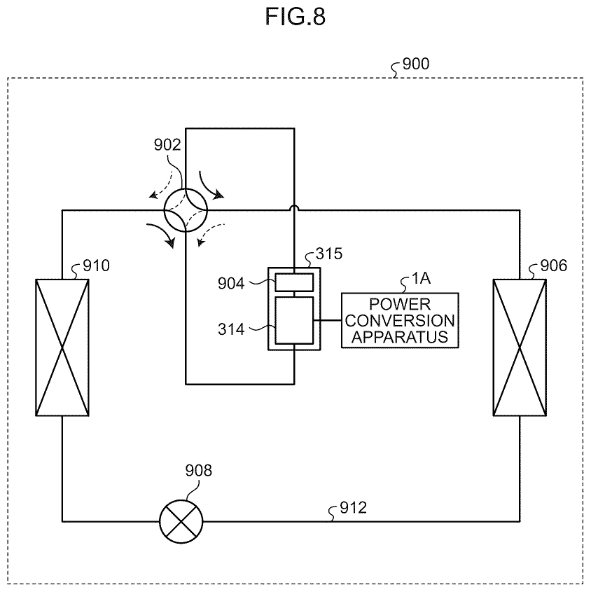

Next, a seventh embodiment will be described with reference to FIG. 8. In the seventh embodiment, the power conversion apparatus is applied to a refrigeration cycle application apparatus. Note that although a case where the power conversion apparatus 1A is applied to a refrigeration cycle application apparatus will be described below, the power conversion apparatuses 1B to 1D may be applied to a refrigeration cycle application apparatus.

FIG. 8 is a diagram illustrating an exemplary configuration of a refrigeration cycle application apparatus according to the seventh embodiment. Note that, in FIG. 8, constituent elements having the same functions as those in the first embodiment are denoted by the same reference numerals as those in the first embodiment.

A refrigeration cycle application apparatus 900 according to the seventh embodiment includes the power conversion apparatus 1A described in the first embodiment. The refrigeration cycle application apparatus 900 according to the seventh embodiment can be applied to products having a refrigeration cycle, such as an air conditioner, a refrigerator, a freezer, and a heat pump water heater.

The refrigeration cycle application apparatus 900 includes the compressor 315, a four-way valve 902, an indoor heat exchanger 906, an expansion valve 908, and an outdoor heat exchanger 910 that are installed via a refrigerant pipe 912. The compressor 315 includes the motor 314 in the first embodiment.

A compression mechanism 904 and the motor 314 are provided inside the compressor 315. The compression mechanism 904 compresses a refrigerant. The motor 314 causes the compression mechanism 904 to operate.

The refrigeration cycle application apparatus 900 can perform heating operation or cooling operation according to switching operation of the four-way valve 902. The compression mechanism 904 is driven by the motor 314 that is under variable speed control.

During the heating operation, the refrigerant is pressurized by the compression mechanism 904 and delivered therefrom, passes through the four-way valve 902, the indoor heat exchanger 906, the expansion valve 908, the outdoor heat exchanger 910, and the four-way valve 902, and returns to the compression mechanism 904, as indicated by solid arrows.

During the cooling operation, the refrigerant is pressurized by the compression mechanism 904 and delivered therefrom, passes through the four-way valve 902, the outdoor heat exchanger 910, the expansion valve 908, the indoor heat exchanger 906, and the four-way valve 902, and returns to the compression mechanism 904, as indicated by broken arrows.

During the heating operation, the indoor heat exchanger 906 acts as a condenser to release heat, and the outdoor heat exchanger 910 acts as an evaporator to absorb heat. During the cooling operation, the outdoor heat exchanger 910 acts as a condenser to release heat, and the indoor heat exchanger 906 acts as an evaporator to absorb heat. The expansion valve 908 decompresses and expands the refrigerant.

As described above, according to the seventh embodiment, since the power conversion apparatus 1A that has been reduced in size and includes the capacitor 210 prevented from deterioration is incorporated in the refrigeration cycle application apparatus 900, it is possible to implement a refrigeration cycle application apparatus having a long life and a small size.

Here, a description will be given of a hardware configuration of the control unit 400 included in each of the power conversion apparatuses 1A to 1D. The control unit 400 included in each of the power conversion apparatuses 1A to 1D is implemented by processing circuitry. The processing circuitry may be a memory and a processor that executes a program stored in the memory, or may be dedicated hardware. Note that since the power conversion apparatuses 1A to 1D have similar hardware configurations, the hardware configuration of the power conversion apparatus 1A will be described below

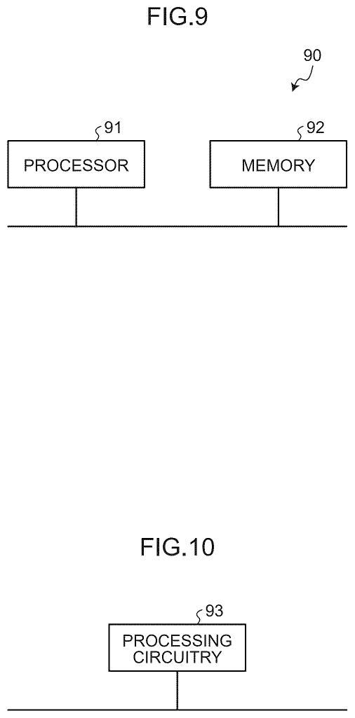

FIG. 9 is a diagram illustrating an exemplary configuration of processing circuitry included in the control unit of the power conversion apparatus according to the first embodiment, the processing circuitry being implemented by a processor and a memory. Processing circuitry 90 illustrated in FIG. 9 includes a processor 91 and a memory 92. In a case where the processing circuitry 90 includes the processor 91 and the memory 92, each function of the processing circuitry 90 is implemented by software, firmware, or a combination of software and firmware. The software or firmware is described as a control program and stored in the memory 92. In the processing circuitry 90, the processor 91 reads and executes the control program stored in the memory 92 to implement each function. That is, the processing circuitry 90 includes the memory 92 for storing the control program that causes processing to be performed in the control unit 400. It can also be said that this control program is a program for causing the control unit 400 to execute each function to be implemented by the processing circuitry 90. This control program may be provided by means of a storage medium in which the control program has been stored, or may be provided by other means such as a communication medium.

Here, the processor 91 is, for example, a central processing unit (CPU), a processing device, an arithmetic device, a microprocessor, a microcomputer, or a digital signal processor (DSP). Furthermore, examples of the memory 92 include nonvolatile or volatile semiconductor memories such as a random access memory (RAM), a read only memory (ROM), a flash memory, an erasable programmable ROM (EPROM), and an electrically EPROM (EEPROM (registered trademark)), a magnetic disk, a flexible disk, an optical disk, a compact disk, a mini disk, and a digital versatile disc (DVD).

FIG. 10 is a diagram showing an example of the processing circuitry included in the control unit of the power conversion apparatus according to the first embodiment, the processing circuitry being implemented by dedicated hardware. For example, a single circuit, a composite circuit, a programmed processor, a parallel-programmed processor, an application specific integrated circuit (ASIC), a field-programmable gate array (FPGA), or a combination thereof is used as processing circuitry 93 illustrated in FIG. 10. A part of the processing circuitry 93 may be implemented by dedicated hardware, and another part of the processing circuitry 93 may be implemented by software or firmware. Thus, the processing circuitry 93 can implement each of the above-described functions by means of dedicated hardware, software, firmware, or combination thereof.

The configurations set forth in the above embodiments show examples, and it is possible to combine the configurations with another known technique or combine the embodiments with each other, and is also possible to partially omit or change the configurations without departing from the scope of the present disclosure.

### REFERENCE SIGNS LIST

1A to 1D power conversion apparatus; 2A to 2D motor drive apparatus; 90, 93 processing circuitry; 91 processor; 92 memory; 110 commercial power supply; 120 reactor; 130 rectifier step-up circuit unit; 200 smoothing unit; 210 capacitor; 310 inverter circuit unit; 311a to 311f switching element; 312a to 312f freewheeling diode; 313a, 313b compressor current detection unit; 314 motor; 315 compressor; 400 control unit; 501 bus current detection unit; 502 smoothing capacitor current detection unit; 503 smoothing capacitor voltage detection unit; 504 input current detection unit; 900 refrigeration cycle application apparatus; 902 four-way valve; 904 compression mechanism; 906 indoor heat exchanger; 908 expansion valve; 910 outdoor heat exchanger; 912 refrigerant pipe; I1 rectified current; I2 inverter input current; I3 capacitor current; P1, P2 connection point; Q1 positive-side bus; Q2 negative-side bus.

1. A power conversion apparatus comprising:
a rectifier step-up circuit to rectify first alternating-current power and boost voltage, the first alternating-current power being supplied from a commercial power supply;
a capacitor connected to an output end of the rectifier step-up circuit;
an inverter circuit to convert power output from the rectifier step-up circuit and the capacitor into second alternating-current power and output the second alternating-current power to a load, the inverter circuit being connected to both ends of the capacitor;
a current detector to detect a current value of current output from the inverter circuit and sent to the load;
a power detector to detect a power state of the capacitor; and
control circuitry to control the rectifier step-up circuit and the inverter circuit, the control circuitry causing the rectifier step-up circuit to irregularly stop boost operation when at least one of a detection value detected by the current detector and a detection value detected by the power detector is a current value indicating an anomaly, the control circuitry controlling the inverter circuit such that the detection value detected by the power detector falls below a first reference value in a case where the detection value detected by the power detector unit is equal to or greater than the first reference value when the boost operation is irregularly stopped.

2. The power conversion apparatus according to claim 1, wherein when a resuming condition for resumption of the boost operation is satisfied during the irregular stop of the boost operation, the control circuitry controls the rectifier step-up circuit such that the rectifier step-up circuit resumes the irregularly stopped boost operation.

3. The power conversion apparatus according to claim 2, wherein
in a case where the boost operation is irregularly stopped, the control circuitry determines whether to resume or inhibit the boost operation, based on a resuming operation period that is a period from resumption of a previous boost operation to an irregular stop of a latest boost operation.

4. The power conversion apparatus according to claim 1, further comprising:
a capacitor current detector to detect a capacitor current flowing through the capacitor, wherein
in a case where a detection value detected by the capacitor current detector is equal to or greater than a second reference value when the boost operation is irregularly stopped, the control circuitry controls the inverter circuit such that the detection value detected by the capacitor current detector falls below the second reference value.

5. The power conversion apparatus according to claim 1, further comprising:
a capacitor voltage detector to detect a voltage across the capacitor, wherein
the control circuitry estimates a capacitor current flowing through the capacitor, based on a detection value detected by the capacitor voltage detector when the boost operation is irregularly stopped, and wherein when the estimated capacitor current is equal to or greater than a third reference value, the control circuitry controls the inverter circuit such that the capacitor current subsequently estimated falls below the third reference value.

6. The power conversion apparatus according to claim 1, further comprising:
an input current detector to detect an input current input by the commercial power supply, wherein
the control circuitry estimates a capacitor current flowing through the capacitor, based on a detection value detected by the input current detector when the boost operation is irregularly stopped, and wherein when the estimated capacitor current is equal to or greater than a fourth reference value, the control circuitry controls the inverter circuit such that the capacitor current subsequently estimated falls below the fourth reference value.

7. A motor drive apparatus comprising the power conversion apparatus according to claim 1.

8. A refrigeration cycle application apparatus comprising the power conversion apparatus according to claim 1.
